(19) United States
(12) Patent Application Publication
(10) Pub. No.: US 2013/0159840 A1
(43) Pub. Date: Jun. 20, 2013

(54) DOCUMENT TEMPLATE DYNAMIC TOKEN POPULATION

(71) Applicant: Cosmin Nicolaescu, Seattle, WA (US)

(72) Inventor: Cosmin Nicolaescu, Seattle, WA (US)

(73) Assignee: MICROSOFT CORPORATION, Redmond, WA (US)

(21) Appl. No.: 13/327,789

(22) Filed: Dec. 16, 2011

(51) Int. Cl. G06F 17/00

(52) U.S. Cl. 715/235

(57) ABSTRACT

A dynamic token system is described herein that allows the insertion of dynamic content into document templates that execute logic at run time to determine content to use to replace the token. A dynamic token is a generic mechanism to add content to a document body. Authors can implement a uniform defined interface, and reference a class containing custom software logic as a token in the document template. When a parser reaches that token, it invokes the dynamic token implementation, which has access to the entire payload and has the appropriate context to act accordingly. Each token can perform a very specific action, augment the payload if necessary, and output the desired information. This mechanism allows administrators to fulfill numerous requirements that are otherwise extremely complicated if not impossible. Thus, the system provides manageable, extensible document templates that can be applied to a wider variety of situations.

### BACKGROUND

Many applications include an activity where there is a need to send bulk email to a variety of users. For example, an event system may send event reminder emails to a variety of users, and a computer operation system may send administrative alerts regarding system status. Before an email can be sent, the body has to be populated. A simplistic system for doing this is to have static text that is sent dynamically to customers. However, that often does not meet user needs since administrators may want to customize content. One way to do so is to take some payload and map it, via extensible stylesheet language transformation (XSLT) to generate hypertext markup language (HTML) content. Once the content needs to be localized, that again does not work.

With any parser, there is an input that is applied to some content (an HTML email template in this case), and the tokens are replaced to generate the consumable output format. In general, there are two types of tokens: input tokens and market-specific content. When an email request is queued, the caller provides some input data that is relevant to the request. The parser takes that data and uses it in generating the email body. Additionally, the parser can also populate market-specific content, such as uniform resource locators (URLs) and branding in order to give the user a localized experience.

For most systems, this is sufficient. However, when dealing with multiple callers and data across multiple systems, new issues arise. For example, it may be that for some languages the order of tokens needs to change. In other situations, there may be particular conditions under which one token is appropriate while in other conditions a different token is appropriate. Such situations currently would involve an administrator maintaining two different templates, two different lists of recipients, and running the email generation twice. This can become a burdensome management task over time as users may need to move from one recipient list to another or other conditions may change.

### SUMMARY

A dynamic token system is described herein that allows the insertion of dynamic content into email or other templates that execute logic at run time to determine content to use to replace the token. A dynamic token is a generic mechanism to add content to an email or other document body. Authors can implement a uniform defined interface, and reference a class containing custom software logic as a token in the email template. When a parser reaches that token, it invokes the dynamic token implementation that has access to the entire payload and has the appropriate context to act accordingly. Each token can perform a very specific action, augment the payload if necessary, and output the desired information. This mechanism allows administrators to fulfill numerous requirements that are otherwise extremely complicated if not impossible. IT personnel and others using the system can easily create new token types for processing various business-specific logic and can generate complex email or other document output from a straightforward and easier to maintain common template. Thus, the dynamic token system provides manageable, extensible document templates that can be applied to a wider variety of situations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the dynamic token system, in one embodiment.

FIG. 2 is a flow diagram that illustrates processing of the dynamic token system to apply one or more dynamic tokens in a document template, in one embodiment.

FIG. 3 is a flow diagram that illustrates processing of the dynamic token system to create a tokenized template including one or more dynamic tokens, in one embodiment.

FIG. 4 is a data flow diagram that illustrates an example flow of data within the system during creation of a document, in one embodiment.

### DETAILED DESCRIPTION

A dynamic token system is described herein that allows the insertion of dynamic content into email or other templates that execute logic at run time to determine content to use to replace the token. A dynamic token is a generic mechanism to add content to an email or other document body. Authors can implement a uniform defined interface, and reference a class containing custom software logic as a token in the email template. When the parser reaches that token, it invokes the dynamic token implementation that has access to the entire payload and has the appropriate context to act accordingly. Each token can perform a very specific action, augment the payload if necessary, and output the desired information. This mechanism allows administrators to fulfill numerous requirements that are otherwise extremely complicated if not impossible.

Following are some examples of replacements possible with dynamic tokens: return localized dates in the appropriate format (i.e. Oct. 15, 2011->Saturday Oct. 15, 2011), calculate values based on input data (i.e. your subscription will expire in 7 days, on Jan. 7, 2011), format HTML content (i.e. shopping cart in an HTML table, list of products, etc.), generate custom URL (i.e. URL containing a hash key to prevent tampering), localized offer name, localized country name from country code, localized state name from state code, pull appropriate content from common HTML file (i.e. based on the country show certain text), obtain password based on username from external system, and suppress further processing of the email based on certain business requirements.

The dynamic token system provides two improvements not available in previous systems. First, the system provides server-side application of tokens on top of existing input data at run time (email processing). Second, the system provides generic declaration of a token interface that allows for easy programmatic extensibility and token configuration per email template. IT personnel and others using the system can easily create new token types for processing various business-specific logic and can generate complex email or other document output from a straightforward and easier to maintain common template. Where different recipients involve different information in the document body, so long as that information can be classified in some common way the dynamic token approach can be used to apply a common template to each of the recipients, with the dynamic token logic providing the heavy lifting for modifying the document output to match the requirements for each recipient. Thus, the dynamic token system provides manageable, extensible document templates that can be applied to a wider variety of situations.

Following is an example process performed by the system to send bulk email using a template that includes dynamic tokens. First, the caller enqueues a request to send an email with some payload. The system stores payload and caller information in a database for future processing. The system enqueues a message for asynchronous processing of emails. On the asynchronous process, the email request is dequeued. The system selects the correct HTML template based on the request and target language of the email. The system loads the selected HTML template in the HTML document object model (DOM) and parses the template by element. If a static input token is identified, the system loads an appropriate value from the payload and the token is replaced in the HTML template. If a static market-specific token is identified (such as FWD links), the appropriate value is loaded from market-specific configuration. If a dynamic token is identified, the appropriate token is loaded using reflection from the running assembly app domain. The system locates a module that implements the dynamic token. Once the dynamic token instance is created, the dynamic token is executed. The output of the dynamic token run replaces the token in the HTML template. The system then re-parses the same HTML element to ensure recursive dynamic tokens are properly handled. These steps are repeated (identifying and processing a dynamic token) until no more dynamic tokens are found in the particular HTML element. Once the entire HTML template is successfully parsed, the email content is fully determined, and the content is then converted to an email message and sent to an SMTP server for delivery to one or more recipients.

Following is a first example interface used by the dynamic token system for defining a new dynamic token class.

/// <summary>
/// Interface which dynamic tokens called from a template implement
/// </summary>
public interface ITemplateDelegate
{

/// <summary>
/// Method which will run the particular dynamic token
/// </summary>
/// <param name=“xml”>The input xml</param>
/// <param name=“rh”> resource handler for this
/// delegate</param>
/// <returns>The text to insert into the template</returns>
string Execute(XContainer xml, ResourceHandler rh);

}

Following is a second example interface used by the dynamic token system for defining a new dynamic token class.

/// <summary>
/// Interface which dynamic tokens called for a rule implement
/// </summary>
public interface IDynamicToken
{

/// <summary>
/// Method which will run the particular dynamic token
/// </summary>
/// <param name=“payload”>The list of key value pairs</param>
void Execute(Dictionary<string, string> payload);

}

Following is an example email template that is specified in HTML and that includes dynamic tokens. Further explanation of each token is provided below.

<html>
<head>

<title>Welcome to your {DEL_OFFER_NAME } subscription</title>
<meta http-equiv=“Content-Type” content=“text/html; charset=UTF-8”

/>

<style type=“text/css”>

.maintxt
{

font-family: Geneva, Arial, Helvetica, sans-serif;
font-size: 13px;
font-style: normal;
line-height: 18px;
font-weight: normal;
font-variant: normal;
color: #666666;

}
.bottomNopaddingNomargin
{

padding-bottom: 0px;
margin-bottom: 0px;

}
ul
{

margin-top: 0;
margin-bottom: 0;

}
ol
{

margin-top: 0;
margin-bottom: 0;

}
.footer
{

font-family: Geneva, Arial, Helvetica, sans-serif;
font-size: 10px;
color: #333333;

}
body
{

margin-top: 0px;
margin-bottom: 0px;

}

</style>

</head>
<body>

<p class=“maintxt” id=“salutation”>

{CM_SUB_SALUTATION_TO_ADDRESS_INFO_PRIMARY_CONTACT_WORK}

</p>
<p class=“maintxt” id=“body_10”>

Welcome to Microsoft Online Services. Your {DEL_OFFER_NAME }

subscription is now

ready for you to use. Your service administrator will need to

go to the Microsoft

Online Services Administration Center to set up and manage your

services.

</p>
<div class=“maintxt”

id=“body_20”>{DEL_BPOS_CREDENTIAL_STEPS }</div>

<p class=“maintxt” id=“body_25”>

Now that you have successfully signed into the Administration

Center, we recommend that you immediately

create a personal administrator account with your own alias.

Use this personal account from now on. Reserve

the {DB_SUB_CUSTOM_ADMIN_UPN} account as a back-up

administrator account.

</p>
<p class=“maintxt bottomNopaddingNomargin” id=“body_30”>

<b>To create a personal administrator account in the

Administration Center:</b>

</p>
<ul class=“maintxt” type=“disc”>

<li id=“body_40”>Follow the instructions in <a

href=“{MK_LINK_CREATE_A_NEW_ACCOUNT_WITH_ADMINISTRATOR_PERMISSIONS }”>

Add an Account with Administrator Permissions</a>.

</li>

</ul>
<p class=“maintxt” id=“body_50”>

If you are not able to sign in to the Administration Center,

contact <a href=“{MK_LINK_ONLINE_SUPPORT }”>

Microsoft Online Services Support</a> immediately to report

this issue.

</p>
<p class=“maintxt bottomNopaddingNomargin” id=“body_60”>

<b>Essential links:</b>

</p>
<ul class=“maintxt” type=“disc”>

<li id=“body_70”>Access the <a href=“{DEL_MOAC_LINK }”>

Microsoft Online Services Administration Center</a></li>

<li id=“body_80”>Register for <a

href=“{MK_LINK_SERVICE_DOWNTIME_NOTIFICATIONS }”>service

notifications</a></li>

<li id=“body_90”>Find out more about using <a

href=“{MK_LINK_MICROSOFT_ONLINE_SERVICES }”>

Microsoft Online Services</a></li>

</ul>
<p class=“maintxt” id=“disclaimer”>

{CM_DISCLAIMER}

</p>
<p class=“maintxt” id=“signature”>

{CM_SIGNATURE}

</p>
<p class=“footer” id=“support”>

{CM_SUPPORT_FOOTER}

</p>
<p class=“footer” id=“privacy”>

{CM_PRIVACY_FOOTER}

</p>
<p class=“footer” id=“trademarks”>

{CM_TRADEMARKS}

</p>

</body>
</html>

In the above example, there are a number of types and instances of example tokens. First, the text “{DEL_OFFER_NAME}” references a dynamic token that is replaced by a localized version of an offer name based on the language for any particular use of the template. The text “{CM_SU B_SALUTATION_TO_ADDRESS_INFO_PRIMARY_CONTACT_WORK}” refers to a common static token that is stored in a centralized HTML file. This allows reuse of certain common phrases and avoids localization costs. The text “{DEL_BPOS_CREDENTIAL_STEPS}” is a dynamic token that looks up the user's password (via an application-programming interface (API) call) and, depending on the outcome, populates the value with either username and password or text instructing the user how to obtain credentials. This is a complex conditional type of operation that is not possible with previous systems. The text “{DB_SUB_CUSTOM_ADMIN_UPN}” is a static input token that represents the customer's username from the payload provided. The text “{MK_LINK_CREATE_A_NEW_ACCOUNT_WITH_ADMINISTRATOR_PERMISSIONS}” is a market token that is replaced with the culture-specific URL for a particular link. The text “PMK_LINK_ONLINE_SUPPORT}” is a similar token for a support URL. The text “{DEL_MOAC_LINK}” is a dynamic token that builds a data-center specific URL. The text “{CM_DISCLAIMER}” and similar at the end are static common tokens that retrieve localized disclaimer, signature, footers, and trademark information text. This example email shows the mixing of several types of tokens provided by the system, including dynamic tokens that execute logic at run time to generate token replacement text.

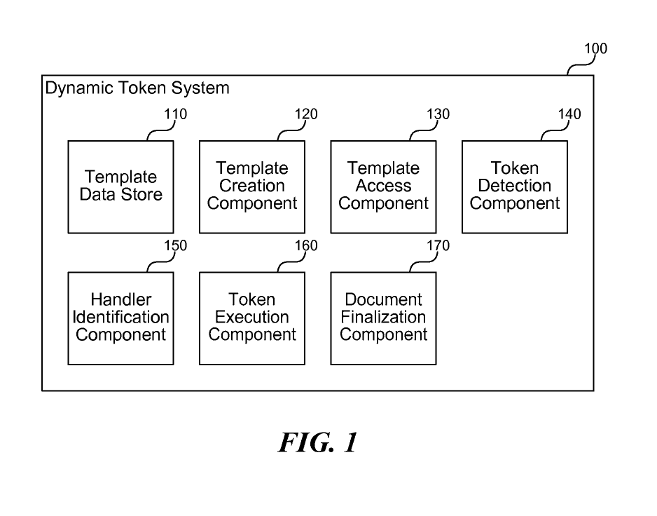

FIG. 1 is a block diagram that illustrates components of the dynamic token system, in one embodiment. The system 100 includes a template data store 110, a template creation component 120, a template access component 130, a token detection component 140, a handler identification component 150, a token execution component 160, and a document finalization component 170. Each of these components is described in further detail herein.

The template data store 110 stores one or more document templates wherein at least one document template includes at least one reference a dynamic token with data populated by executing a dynamic token handler during processing of the template. The template data store 110 may include one or more files, file systems, hard drives, databases, storage area networks, cloud-based storage services, or other facilities for persisting data over time. The template data store 110 provides access to template creators to store new templates and update previously created ones, and provides access to template users to populate a template for a particular document creation run. The template data store 110 may also store generic payload data for populating static template tokens, such as a company name, company location, recipient names, and so forth.

The template creation component 120 provides an interface to template creators to create and modify document templates and store the created or modified document templates in the template data store 110. The interface may include a web page, mobile application, desktop application, programmatic interface, or other interface for accessing the system 100 and providing template information to the template creation component 120. The interface may provide an editing environment for use during a design phase to populate templates with common controls, static input tokens, static market-specific tokens, branding information, dynamic tokens, as well as non-tokenized static text or other data. Templates may include textual, audiovisual, logo, or other types of information and data.

The template access component 130 provides access to templates stored in the template data store 110 to template users for creation of documents based on the templates. For example, an administrative user may access the template access component 130 to select a template for sending an email to one or more identified recipients. The user may provide payload or other information that is used during the template population process described herein. The template access component 130 invokes the token detection component 140 to process any static and dynamic tokens referenced by the selected template, and then invokes the document finalization component 170 to send the document (in the case of email) or finalize the document in some other way for a particular task. The template access component 130 may provide an interface through which users access the system 100 for using templates, such as a web page, mobile application, desktop application, or programmatic interface.

The token detection component 140 detects one or more tokens in a selected document template and processes the tokens to populate a document instance derived from the template with appropriate text or other data. For dynamic tokens, the token detection component 140 invokes the handler identification component 150 to identify an appropriate handler and the token execution component 160 to retrieve replacement data for the token. The token detection component 140 may also handle a variety of types of static tokens, such as input tokens, market-specific tokens, and branding information. Static tokens are those that do not involve the execution of a custom token handler at run time and generally involve a one-to-one replacement of some named token with a specific piece of data identified with that name. For example, the data may include an icon, a name, an address, and so forth. Static token data may still vary by run based on conditional information selected in the payload. For example, a particular run of the document generation may indicate that Spanish language token data be used to fill in a particular document template while another run may indicate that English language token data be used.

The handler identification component 150 identifies a software handler for an identified dynamic token referenced in the selected document template. In some embodiments, the dynamic token reference is a class name of a software class (e.g., MICROSOFT™ .NET class) implemented in a program module and supplied by a third party developer or the system implementer. In other cases, the system may map friendly token reference names to class names through a level of indirection that allows renaming or replacing a particular class of dynamic token handler. The handler identification component 150 may search a designated repository of token handlers (e.g., stored in a particular folder or identified in a particular configuration database key, such as the MICROSOFT™ WINDOWS™ Registry). Upon finding the token handler, the handler identification component 150 invokes the token execution component 160 to execute the token handler, and then may pass control back to the token detection component 140 to reprocess the replacement text for any embedded tokens or to continue detect tokens elsewhere in the selected document template.

The token execution component 160 executes an identified software handler for an identified dynamic token in the selected document template. Because dynamic tokens execute custom software code, they can do virtually anything to generate the replacement text for the token. This may include testing particular environment data or other conditions present at the time of execution, querying information from local or remote data stores, or performing any other action envisioned by a token handler implementer. The system 100 is designed to allow flexibility to solve a variety of real-world problems and can be extended over time by the addition of new dynamic tokens and associated handlers to perform any useful action. The output of executing the identified software handler is replacement text or other data that is filled into the document instance being created based on the selected document template. The output may include addition static or dynamic token references, and the system 100 may recursively process the output text to resolve any embedded token references. The system 100 may also take steps to avoid circular token references (e.g., limiting the level of recursion or testing for already referenced token handlers).

The document finalization component 170 finalizes the document instance derived from the selected document template after each of the token references in the template has been resolved. Finalization may include sending the document as an email message, displaying the document to a user for review, storing the document in a document data store, posting the document to a web site, or any other activity that makes the document available for the next step in a process of which the document is a part. The system 100 may also provide status information to a user of the system 100 to inform the user of the document progress and finalization as well as highlighting any errors that occur during the processing of the selected document template (e.g., a dynamic token handler that could not be found, missing payload data, and so forth).

The computing device on which the dynamic token system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

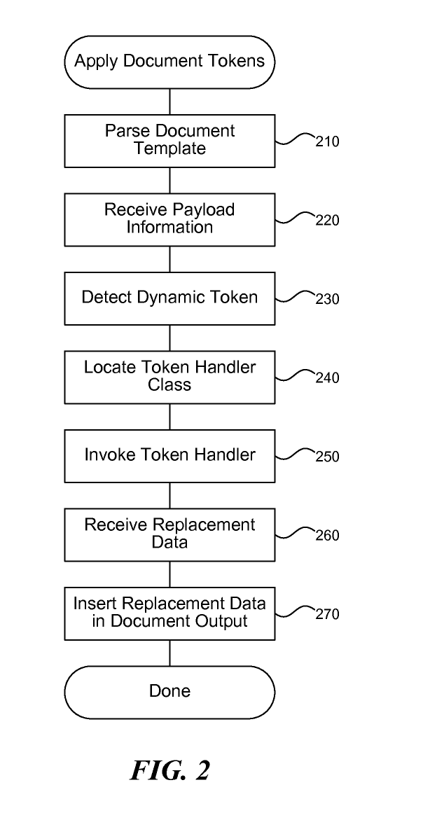

FIG. 2 is a flow diagram that illustrates processing of the dynamic token system to apply one or more dynamic tokens in a document template, in one embodiment. Beginning in block 210, the system parses a received document template to identify one or more tokens that provide replacement data for part of the template, wherein at least one token is a dynamic token that causes dynamic determination of replacement data. The system may receive a selection of a document template through an interface provided to users by the system and begin parsing the document template from top to bottom. In some cases, the system loads the document template in a DOM for enumerating the contents of the document template.

Continuing in block 220, the system receives payload information that specifies data associated with at least one instance of a document to be created based on the selected template. The payload information may include replacement text for predefined static tokens, conditional information that is used by dynamic tokens, background information related to the purpose of creating the document instance, and so on. The payload information may be stored in a data store or accompany the request to create the document instance as a parameter or other metadata.

Continuing in block 230, the system detects a dynamic token in the received document template. As the system parses the document template, the system may discover tokens based on a particular text format, escape character, or other information that signals the presence of a particular token. A token is represented by a reference that includes at least a name and possibly type information. The name may also include type information. For example, token names may include a prefix that indicates the token type. Upon discovery of a token, the system determines the token's type, and if the token is a dynamic token, the system continues to the next block to locate a handler for the dynamic token.

Continuing in block 240, the system locates a token handler that includes custom software code for generating replacement data for the detected dynamic token. The system may locate the token handler by using the name of the token or other information discovered in the token reference within the selected template to identify the handler for the dynamic token. For example, the name may correspond to the name of a software class that implements behavior through software logic associated with the dynamic token. Upon locating the token handler, the system may load a module associated with the handler, create an instance of the handler's class, and retrieve an entry point address for invoking the handler.

Continuing in block 250, the system invokes the located token handler to execute the custom software code and generate replacement data for the dynamic token. Dynamic token handlers can perform a variety of actions and may generate replacement data for the token in any manner determined by the token author. For example, the handler may retrieve data from a local or remote data source, evaluate environmental conditions (e.g., current user, time, location, and so on) of the current use of the template, look up user information, and so forth. The token handler may provide static replacement data or data that includes additional static or dynamic tokens. Thus, the system may recursively process the replacement data to handle any embedded tokens.

Continuing in block 260, the system receives replacement data as output from the invoked token handler. The replacement data may include text, images, audiovisual data, or any other type of data suitable for the document type being created and associated with the selected document template. The token handler may provide a function that the system invokes and that provides replacement data as an output parameter or via another mechanism (e.g., saving the replacement data to a well-known location).

Continuing in block 270, the system inserts the received replacement data into the created instance of the document based on the received document template. The system may preprocess the replacement data to handle any embedded tokens before or after inserting the replacement data into the document instance. Any embedded tokens may lead to further replacements of document data. After block 270, these steps conclude.

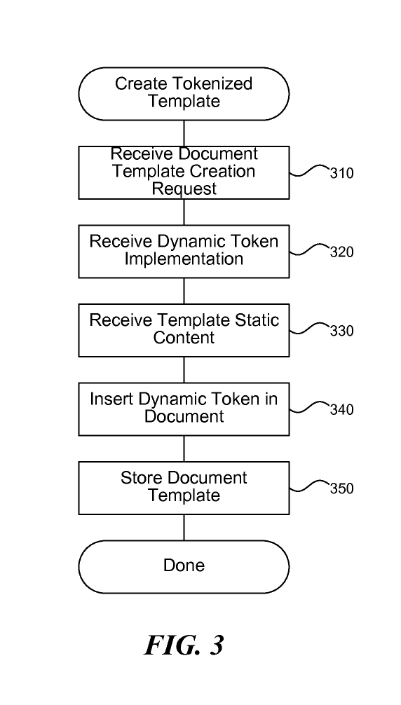

FIG. 3 is a flow diagram that illustrates processing of the dynamic token system to create a tokenized template including one or more dynamic tokens, in one embodiment. Beginning in block 310, the system receives a request to create a tokenized document template for creating document instances using replacement data from one or more replaceable tokens. The system may provide an interface as described herein for creating new document templates. The interface may provide an editing environment through which template authors can construct various types of document templates, such as email templates for sending dynamically generated email to users of the system.

Continuing in block 320, the system receives a module that implements at least one dynamic token handler, wherein a dynamic token handler provides dynamically executable software code for determining contents of replacement data at run time during creation of a document instance based on the document template. The module may include a class, interface, well-known entry point, or other software facility for identifying the location of the dynamic token handler. For example, the handler may implement one of the two example interfaces provided herein. Handler authors may install the module and register the module so that the system can locate the module during document instance creation.

Continuing in block 330, the system receives template static content that defines at least part of the body of the template. Static content may include text, images, audiovisual data, static replacement tokens, and other information that fill in the body of the document template during creation of a document instance. For example, a particular document template may include a large percentage of static text with several tokenized portions for inserting replacement data during document instance creation.

Continuing in block 340, the system inserts at least one reference to a dynamic token into the document template. The inserted dynamic token identifies the received dynamic token handler for processing the dynamic token during run time of the document template. For example, the dynamic token reference may include a name that is the same as a name of a software class that implements the dynamic token handler. The reference name may also include information identifying the token type as a dynamic one to differentiate the dynamic token from other types of tokens.

Continuing in block 350, the system stores the created document template including the at least one reference to the dynamic token in a template data store. The system may store templates in a database, cloud-based storage service, or other facility where users of the system can later access one or more available templates to dynamically generate documents using the templates. After block 350, these steps conclude.

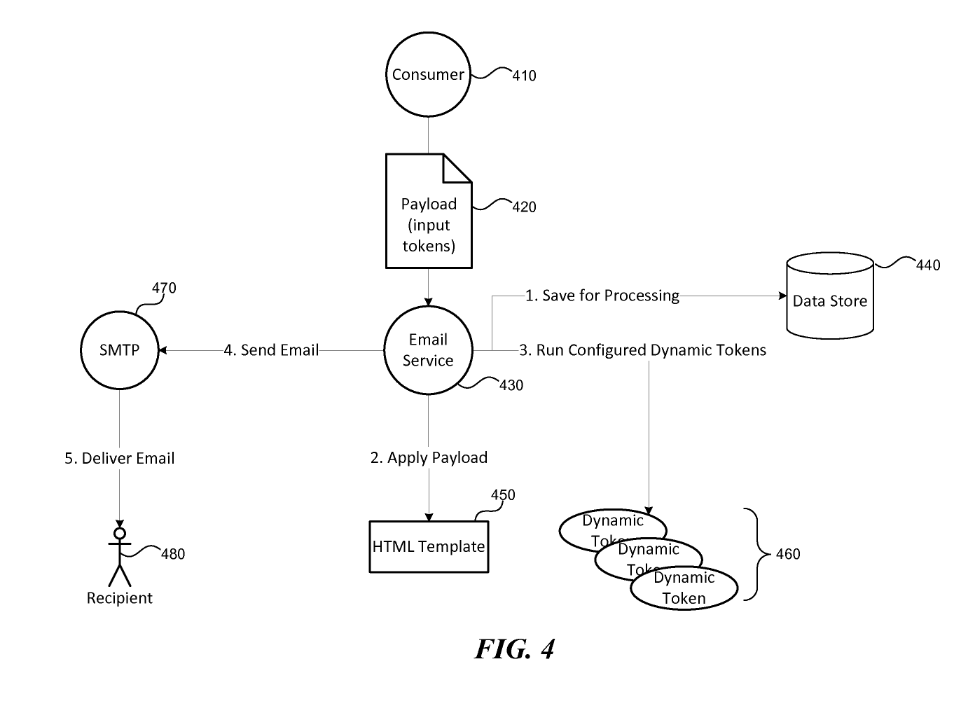

FIG. 4 is a data flow diagram that illustrates an example flow of data within the system during creation of a document, in one embodiment. A user of the system 410 provides payload data 420 to an email service 430 that implements the dynamic token system described herein. The email service 430 saves the payload data to a data store 440 for use during processing of an HTML template 450. The HTML template 450 may also be stored and retrieved from the data store 440 (not shown). The email service 430 applies the payload data 420 to the HTML template 450 and runs any dynamic tokens 460 referenced within the HTML template 450. The dynamic tokens 460 and any static tokens replace any variable data in the HTML template 450 with appropriate data for the current use of the template 450. After completion of the document (in this example an email message), the system invokes a simple mail transfer protocol (SMTP) service 470 to send the document to a recipient 480.

From the foregoing, it will be appreciated that specific embodiments of the dynamic token system have been described herein for purposes of illustration, but that various modifications may be made without deviating from the spirit and scope of the invention. Accordingly, the invention is not limited except as by the appended claims.

I/We claim:

1. A computer-implemented method to apply one or more dynamic tokens in a document template, the method comprising:
parsing a received document template to identify one or more tokens that provide replacement data for part of the template, wherein at least one token is a dynamic token that causes dynamic determination of replacement data;
receiving payload information that specifies data associated with at least one instance of a document to be created based on the selected template;
detecting a reference to a dynamic token in the received document template;
locating a token handler that includes custom software code for generating replacement data for the detected dynamic token;
invoking the located token handler to execute custom software code associated with the dynamic token and generate replacement data for the dynamic token;
receiving replacement data as output from the invoked token handler; and
inserting the received replacement data into the created instance of the document based on the received document template,
wherein the preceding steps are performed by at least one processor.

2. The method of claim 1 wherein parsing the received document template comprises receiving a selection of a document template through an interface provided to users by the system.

3. The method of claim 1 wherein parsing the received document template comprises loading the document template in a document object model (DOM) for enumerating the contents of the document template.

4. The method of claim 1 wherein receiving payload information comprises receiving at least one of replacement text for predefined static tokens, conditional information that is used by dynamic tokens, and background information related to the purpose of creating the document instance.

5. The method of claim 1 wherein receiving payload information comprises accessing payload information stored in a data store associated with the received document template.

6. The method of claim 1 wherein detecting the dynamic token comprises, during parsing of the document template, discovering one or more tokens based on a particular text format that signals the presence of a particular token.

7. The method of claim 1 wherein detecting the dynamic token comprises identifying a token type based on a name of the token.

8. The method of claim 1 wherein locating the token handler comprises locating the token handler by using a name of the token discovered in the token reference within the selected template to identify the handler for the dynamic token.

9. The method of claim 1 wherein locating the token handler comprises identifying a software class that implements behavior through software logic associated with the dynamic token.

10. The method of claim 1 further comprising, upon locating the token handler, loading a module associated with the handler, creating an instance of the handler's class, and retrieving an entry point for invoking the handler.

11. The method of claim 1 wherein receiving replacement data comprises invoking a function provided by the token handler that provides replacement data as an output parameter.

12. The method of claim 1 wherein receiving replacement data comprises receiving replacement data that includes at least one embedded token and further comprising processing the replacement data to handle the embedded token.

13. The method of claim 1 wherein inserting replacement data comprises creating an email message and further comprising sending the email message to an identified recipient.

14. A computer system for document template dynamic token population, the system comprising:
a processor and memory configured to execute software instructions embodied within the following components;
a template data store that stores one or more document templates wherein at least one document template includes at least one reference a dynamic token with data populated by executing a dynamic token handler during processing of the template;
a template creation component that provides an interface to template creators to create and modify document templates and store the created or modified document templates in the template data store;
a template access component that provides access to templates stored in the template data store to template users for creation of documents based on the templates;
a token detection component that detects one or more tokens in a selected document template and processes the tokens to populate a document instance derived from the template with appropriate text or other data;
a handler identification component that identifies a software handler for an identified dynamic token referenced in the selected document template;
a token execution component that executes an identified software handler for an identified dynamic token in the selected document template; and
a document finalization component that finalizes the document instance derived from the selected document template after each of the token references in the template have been resolved.

15. The system of claim 14 wherein the template data store provides access to template creators to store new templates and update previously created ones, and provides access to template users to populate a template for creation of document instances.

16. The system of claim 14 wherein the template data store also stores generic payload data for populating static template tokens.

17. The system of claim 14 wherein the token detection component invokes the handler identification component to identify an appropriate handler and the token execution component to retrieve replacement data for the token.

18. The system of claim 14 wherein the token detection component also handles one or more types of static tokens that do not involve the execution of a custom token handler at run time.

19. The system of claim 14 wherein the handler identification component detects a dynamic token reference that is a class name of a software class implemented in a program module.

20. A computer-readable storage medium comprising instructions for controlling a computer system to create a tokenized template including one or more dynamic tokens, wherein the instructions, upon execution, cause a processor to perform actions comprising:
receiving a request to create a tokenized document template for creating document instances using replacement data from one or more replaceable tokens;
receiving a module that implements at least one dynamic token handler, wherein a dynamic token handler provides dynamically executable software code for determining contents of replacement data at run time during creation of a document instance based on the document template;
receiving template static content that defines at least part of a body of the template;
inserting at least one reference to a dynamic token into the document template; and
storing the created document template including the at least one reference to the dynamic token in a template data store.
